(19) United States
(12) Patent Application Publication
(10) Pub. No.: US 2010/0164838 A1
(43) Pub. Date: Jul. 1, 2010

(54) DISPLAY DEVICE

(75) Inventors: Andrew John Fisher, Cambridge (GB); Timothy Holroyd Glauert, Cambridgeshire (GB); James Quentin Stafford-Fraser, Cambridge (GB)

Correspondence Address: BROOKS KUSHMAN P.C., 1000 TOWN CENTER, TWENTY-SECOND FLOOR, SOUTHFIELD, MI, 48075, US

(73) Assignee: DISPLAYLINK (UK) LIMITED, Cambridge (GB)

(21) Appl. No.: 12/063,168

(22) PCT Filed: Aug. 11, 2006
(86) PCT No.: PCT/GB06/03006

§ 371 Date: Feb. 7, 2008

(30) Foreign Application Priority Data
Aug. 13, 2005 (GB) 0516710.1

(51) Int. Cl. G09G 5/00

(52) U.S. Cl. 345/2.1

(57) ABSTRACT

A display device for transmitting, over a general purpose data network, graphical data to a remote device, the display device comprising a framebuffer memory for storing the graphical data; and a network interface for maintaining two-way network transmission of graphical data to and from the display device and operable to read or write to the framebuffer memory; wherein the network interface transmits the contents of the framebuffer memory to at least one remote device over the network.

The present invention relates to the monitoring of display devices at remote locations.

The ability to read a screen remotely has many advantages. A user may wish to operate their PC from a remote location. A teacher may wish to check up on the activities of her pupils. A financial institution or a call-centre may need to monitor the activities of their employees. A help-desk assistant may need to see the problem that a user is describing to them over the phone. Two or more people may wish to see the same display during a conference call. Software to enable such remote viewing is available, but must be installed on the user's machine, is dependent on the operating system currently in use, and is generally not usable before the operating system has booted, for example in a PC's ‘CMOS Setup’ screen.

As the speed and ubiquity of data networks increases and the cost falls, it becomes more and more viable to connect a variety of computer peripherals directly to a network rather than using the more traditional specialised cable plugged into the back of a PC. We are now starting to see products allowing desktop graphics to be sent over USB, Ethernet or wireless networks to a networked video adaptor which displays the output on an attached monitor. Current remote viewing systems do not take advantage of these recent developments in display technology.

According to the present invention, there is provided a display device for transmitting, over a general purpose data network, graphical data to a remote device, the display device comprising:

framebuffer memory for storing the graphical data; and

a network interface for maintaining two-way network transmission of graphical data to and from the display device and operable to read or write to the framebuffer memory;

wherein the network interface transmits the contents of the framebuffer memory to at least one remote device over the network.

Advantageously, the display device may further comprise: a display screen for presenting graphical data visually; driver circuitry for receiving the graphical data from the network interface and converting the data into pixel values; and a raster module for taking the pixel values and rastering them onto the display screen, thereby displaying the graphical data on the display device.

It is preferred that the network interface transmits data under instructions from the local display device.

Alternatively, the network interface transmits data under instructions from the remote device.

The remote device may itself be a display device. Alternatively, it may be a recording device.

According to a further aspect of the invention, there is provided a method for transmitting graphical data over a general purpose data network to a remote device, where that graphical data is also presented visually on a local display device, the method comprising:

storing in a framebuffer memory the graphical data for display on a local display device;

maintaining two-way network transmission of graphical data to and from the display device;

reading data from the framebuffer memory; and

transmitting the contents of the framebuffer memory to at least one remote device over the network.

The method may further comprise: receiving the graphical data from the framebuffer memory; converting the graphical data into pixel values; and rastering the pixel values onto a display screen in the local display device.

In one preferred alternative, the step of transmitting the contents of the framebuffer memory may comprise: receiving instructions from the local display device; and transmitting the contents in accordance with the instructions.

In another alternative, the step of transmitting the contents of the framebuffer memory comprises: receiving instructions from the remote device; and transmitting the contents in accordance with the instructions.

Examples of the present invention will now be described in detail with reference to the accompanying drawings, in which:

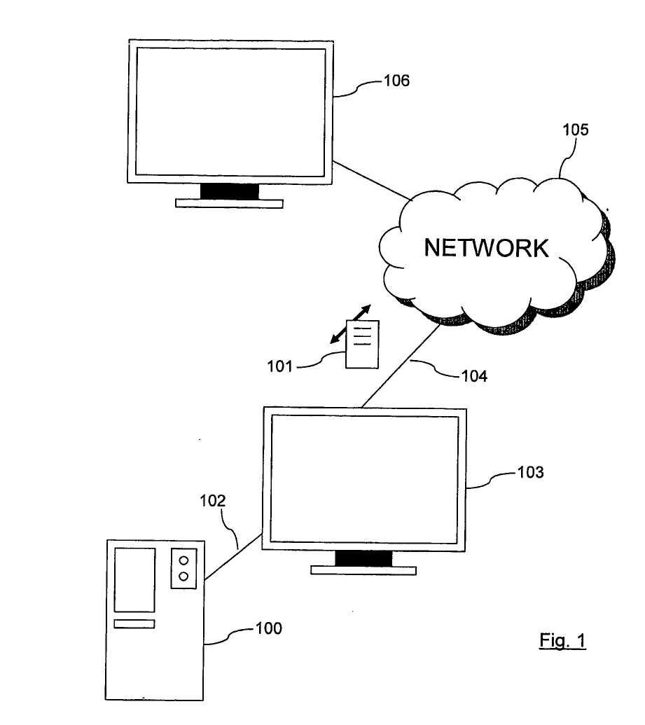

FIG. 1 shows a network configuration to which the present invention is to suited; and

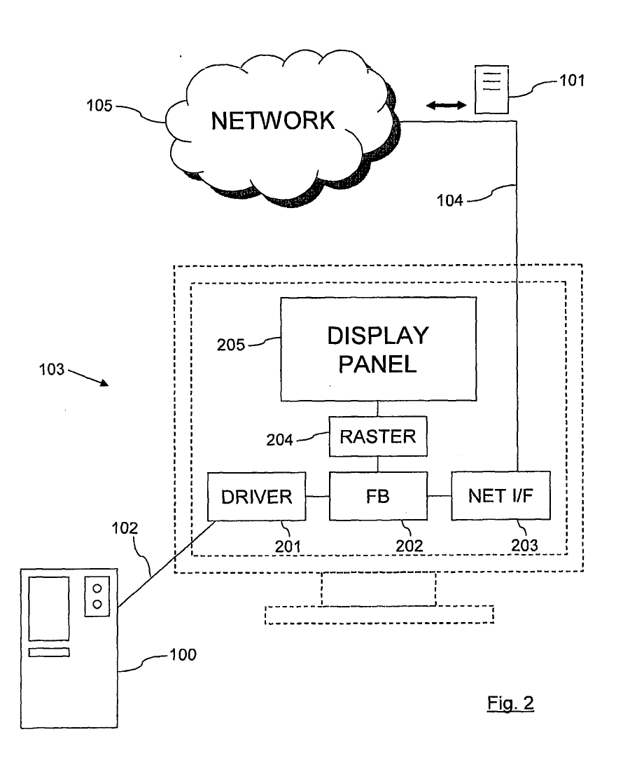

FIG. 2 shows diagrammatically the components of a monitorable display device in accordance with the present invention.

The invention provides a monitor which has both standard video and network connections for remote reading of a screen by the use of a networked video adaptor, where the networked video adaptor has been incorporated into the monitor itself. Such a monitor could receive its data from either a standard video connection such as VGA, DVI or S-Video, or via a general-purpose data network such as USB, Ethernet, IEEE-1394, Bluetooth, 802.11 or UWB wireless. It might switch between the two types of connections under user control, perhaps via a selection button on the front panel, or automatically, or the two streams may be merged in some way. An example would be where company-wide announcements sent over the network could pop-up briefly on a user's screen (which was also attached to their PC for normal use).

However, an important distinction between most traditional video connections and most general purpose networks is that the latter are bi-directional. They can be used both to send and receive data. It therefore follows that a display with a network connection could transmit the contents of its screen to another location as well as receiving the contents from another location. It could even do both, for example receiving updates from one location and sending them on to another. This could be important in a situation where the integrity of the on-screen data is important and where the contents must be confirmed by being read back after being sent.

The monitor is capable of receiving screen updates over either traditional (e.g. VGA) or network connections and also to transmit the contents of the screen over the network connection to a remote location. By building this functionality into a user's screen, it can be available without the restrictions of previous systems (for example the dependence on operating system and the need to install software on the user's system).

In many circumstances there will be security and privacy concerns associated with a remote operator being able to view a user's screen. It may be important for this functionality only to be enabled by the user's explicit request, for example by selecting an option in the monitor's configuration menu. It may even be that the user initiates the sending of the monitor's contents to a particular location, rather than the screen being read in a process initiated from the remote end. Alternatively, some visual indicator such as a warning light or a change in the screen display could be used to indicate when the screen was being examined.

Using the invention, it is possible to connect two screens ‘directly’ over the network, so that the contents of one screen are shown on another without the need for an intervening computer. Such a connection could be initiated at either end or by another entity on the network.

Referring to FIG. 1, a PC 100 has a monitor 103 attached to it by a standard video connection such as VGA or DVI 102. The monitor is also connected to a general-purpose data network 105 via a network cable or wireless link 104. Also connected to the network is a second monitor 106. The contents of the first display 103 are created and updated over the conventional connection 102 but are also sent, as graphical data 101, through the data network 105 to the second monitor 106. This configuration may be created and managed by another entity on the network, by one of the monitors or by software on the PC 100, which may itself be connected to the network.

The monitor 103 contains framebuffer memory, which is used to maintain the display contents and which may be written to by either the conventional interface with the PC 100 or via a network interface, and may be read by the network interface. FIG. 2 illustrates the internal workings of the monitor 103 in such an implementation. The ‘driver’ circuitry 201 takes the video signal from the PC 100 or other source and converts it into pixel values to be displayed, possibly performing digital-to-analogue conversion, scaling, colour correction or other conversion in the process. These pixel values are stored, as graphical data 101, in the framebuffer memory 202. A module 204 is responsible for taking those pixel values and rastering them onto (or otherwise driving) the display panel 205.

The network interface module 203 is also able to read from or write to the framebuffer memory 202, and can be configured or requested to transmit the contents (the graphical data 101), possibly compressed and possibly encrypted, to one or more remote locations over the network 105. This transmission may be initiated by the circuitry of the local display device 103, for example when the contents of the framebuffer 202 are updated, or by the user of the PC 100, or by the remote receiving entity (such as the display 106 of FIG. 1), or by some other entity on the network, including the PC 100.

Other aspects of the display's operation may also be reported over the network. As an example, when the display is switched off or goes into standby power-saving mode, a signal may be sent over the network causing other displays which were receiving its data also to switch off or go into standby mode. If the input signal changes to a different resolution, causing the monitor to do the same, it may instruct remote displays to follow suit.

The remote device need not actually be a display. It may be a piece of software or some other device, such as a recording device. It may display the received contents, but it may process them in some other way, for example saving the display stream to disk, modifying it for use in a different context (such as on a different-resolution device) or performing some analysis, such as analysing the amount of activity on the screen.

1. A display device for transmitting, over a general purpose data network, graphical data to a remote device, the display device comprising:
framebuffer memory for storing the graphical data; and
a network interface for maintaining two-way network transmission of graphical data to and from the display device and operable to read or write to the framebuffer memory;
wherein the network interface transmits the contents of the framebuffer memory to at least one remote device over the network.

2. A display device as claimed in claim 1, further comprising:
a display screen for presenting graphical data visually;
driver circuitry for receiving the graphical data from the network interface and converting the data into pixel values; and
a raster module for taking the pixel values and rastering them onto the display screen, thereby displaying the graphical data on the display device.

3. A display device as claimed in claim 1, wherein the network interface transmits data under instructions from the local display device.

4. A display device as claimed in claim 1, wherein the network interface transmits data under instructions from the remote device.

5. A display device as claimed in claim 1, wherein the remote device is a display device.

6. A display device as claimed in claim 1, wherein the remote device is a recording device.

7. A method for transmitting graphical data over a general purpose data network to a remote device, where that graphical data is also presented visually on a local display device, the method comprising:
storing in a framebuffer memory the graphical data for display on a local display device;
maintaining two-way network transmission of graphical data to and from the display device;
reading data from the framebuffer memory; and
transmitting the contents of the framebuffer memory to at least one remote device over the network.

8. A method as claimed in claim 7, further comprising:
receiving the graphical data from the framebuffer memory;
converting the graphical data into pixel values; and
rastering the pixel values onto a display screen in the local display device.

9. A method as claimed in claim 7, wherein the step of transmitting the contents of the framebuffer memory comprises:
receiving instructions from the local display device; and
transmitting the contents in accordance with the instructions.

10. A method as claimed in claim 7, wherein the step of transmitting the contents of the framebuffer memory comprises:
receiving instructions from the remote device; and
transmitting the contents in accordance with the instructions.

11. A method as claimed in claim 7, wherein the remote device is a display device.

12. A method as claimed in claim 7, wherein the remote device is a recording device.
